(19) United States
(12) Patent Application Publication
(10) Pub. No.: US 2009/0214715 A1
(43) Pub. Date: Aug. 27, 2009

(54) Novel cookie icing, and methods of making and using same

(75) Inventors: Shirley Duke, Ocala, FL (US); Lanier Fender, Ocala, FL (US); Jack Grosskopf, Ocala, FL (US)

Correspondence Address: COHEN, PONTANI, LIEBERMAN & PAVANE LLP, 551 FIFTH AVENUE, SUITE 1210, NEW YORK, NY, 10176, US

(73) Assignee: Signature Brands LLC, Ocala, FL (US)

(21) Appl. No.: 12/072,033

(22) Filed: Feb. 22, 2008

(51) Int. Cl. A23G 3/50; B65D 81/32; A23G 3/28; A23P 1/08

(52) U.S. Cl. 426/87; 426/659; 426/115; 426/120; 426/383

(57) ABSTRACT

This invention provides a decorative icing comprising (a) sugar in an amount of between 65% and 85% by weight; (b) water in an amount of between 8% and 16% by weight; (c) corn syrup in an amount of between 1.5% and 7% by weight; and (d) a gum blend in an amount of between 0.3% and 1% by weight, the gum blend comprising, in descending order of amount, gum arabic, propylene glycol alginate and xanthan gum; wherein the icing is ready to use, flowable, protein-free, and hardens after exposure to air. This invention also provides related articles of manufacture, kits, and methods for making and using the instant icing.

### BACKGROUND OF THE INVENTION

### Field of the Invention

Throughout this application, various publications are cited. The disclosure of these publications is hereby incorporated by reference into this application to describe more fully the state of the art to which this invention pertains.

### Icings Generally

Icing is a sugar-based confection used to cover or decorate cakes, cupcakes, cookies, pastries and other baked products. It often contains a fat portion, which may be dairy, shortening or oil. It may contain a protein source such as egg products, milk or soy protein. It can also contain other ingredients that allow for specific characteristics.

The simplest icing is a glace icing, made of confectioner's sugar and water. The thinness of this icing makes it well suited for pouring over pastries such as danish, donuts, and cakes. More complicated icings are made by incorporating fats into the sugar, by heating fat and sugar together, by adding a protein source or by adding other ingredients such as glycerin to make the icing more elastic. Icing systems based on these types of additions are known as butter cream, whipped, royal, fondant, gum paste, and marzipan icings.

Icings can be applied to the surface of confections using a piping bag, pouring, dipping, rolling and draping, or spreading with a utensil. Icings can also be used to form decorations such as roses, leaves or figurines. Icings may be colored or flavored to match the decorating occasion or theme.

### Royal Icing

Royal icing is historically made using sugar, water, egg whites, and glycerin. For example, homemade royal icing is made using powdered sugar, warm water, meringue powder, vanilla extract, cream of tartar and food coloring.

The use of raw eggs is discouraged today due to the risk of salmonella. Royal icing is frequently made with meringue powder instead, a combination of pastuerized dried egg whites, gum arabic, and cream of tartar.

Royal icing is a versatile decorative icing, in that by adjusting the viscosity or thickness of the icing, it can have two totally different uses. A thicker royal icing is used to create piped shapes and defined borders, while a thinner royal icing is applied on cookies to create smooth palettes that can then be used as a canvas for decorating with other icings, colored sugars or sprinkle decorations.

Royal icing products at present are not ready-to-use products. These market offerings included, previously and now a Wilton meringue powder. The user must measure out confectioner's sugar and water to be mixed with the powder in a bowl. Color and flavor, if desired, are also added by the user. This mixture was then transferred to a piping bag for use. The meringue powder product produces a superior looking covering, but requires additional ingredients, kitchen utensils, measuring and clean-up.

Also available in the past, a Wilton Industries, Inc. (Wilton) pouched icing named Ice-A-Cookie® that required heating in a bowl of hot water. The pouch was kneaded and then opened by snipping a tip with a pair of scissors. It could be resealed if not consumed in a single use. Disadvantages of the pouched Ice-a-Cookie® product were that (i) one had to heat it prior to use; (ii) if overheated, the icing was too fluid and difficult to control when icing a cookie; (iii) if under-heated, the icing was difficult to dispense, was thick and did not flow to cover the cookie; and (iv) the icing produced a dull finish.

Wilton now offers the same pouch icing renamed Cookie Icing in a squeeze bottle that is heated in the microwave and kneaded before use. The ingredient statements are the same with only the order of ingredients changing.

### SUMMARY OF THE INVENTION

This invention provides a first decorative icing comprising (a) sugar in an amount of between 65% and 85% by weight; (b) water in an amount of between 8% and 16% by weight; (c) corn syrup in an amount of between 1.5% and 7% by weight; and (d) a gum blend in an amount of between 0.3% and 1% by weight, the gum blend comprising, in descending order of amount, gum arabic, propylene glycol alginate and xanthan gum; wherein the icing is ready to use, flowable, protein-free, and hardens after exposure to air.

This invention also provides a second decorative icing comprising (a) sugar in an amount of between 79% and 80% by weight; (b) water in an amount of between 13% and 14% by weight; (c) corn syrup in an amount of 5% by weight; (d) a gum blend in an amount of 0.85% by weight, the gum blend comprising, in descending order of amount, gum arabic, propylene glycol alginate and xanthan gum; (e) citric acid in an amount of 0.07% by weight; (f) butter vanilla flavor in an amount of 0.1% by weight; and (g) potassium sorbate in an amount of 0.10% by weight; wherein the icing is ready to use, flowable, protein-free, and hardens after exposure to air.

This invention further provides a first article for use in decorating a confection with icing comprising a squeezable pouch having (a) the first decorative icing therein, and (b) a re-closable pouch fitment which, once opened, serves as an aperture through which the icing flows upon the pouch being squeezed. This invention also provides a second article for use in decorating a confection with icing comprising a squeezable pouch having (a) the second decorative icing therein, and (b) a re-closeable pouch fitment which, once opened, serves as an aperture through which the icing flows upon the pouch being squeezed.

This invention further provides a first kit for use in decorating a confection with icing comprising a packaging material and a plurality of the first articles, wherein each article in the kit contains icing which is colored differently than the icing in at least one other article in the kit. This invention further provides a second kit for use in decorating a confection with icing comprising a packaging material and a plurality of the second articles, wherein each article in the kit contains icing which is colored differently than the icing in at least one other article in the kit.

This invention also provides a method for making the first decorative icing comprising the steps of (a) admixing a gum solution with sugar, wherein the gum solution comprises water, potassium sorbate and, in descending order of amount, gum arabic, propylene glycol alginate and xanthan gum; (b) to the resulting mixture, admixing corn syrup for a suitable period of time; (c) to the resulting mixture, admixing sugar and citric acid for a suitable period of time; and (d) to the resulting mixture, admixing sugar for a suitable period of time.

Finally, this invention provides methods for decorating a confection comprising applying the first or second decorative icing to the confection, and permitting the icing so applied to dry. The confections so decorated are also provided.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

This invention provides a first decorative icing comprising (a) sugar in an amount of between 65% and 85% by weight; (b) water in an amount of between 8% and 16% by weight; (c) corn syrup in an amount of between 1.5% and 7% by weight; and (d) a gum blend in an amount of between 0.3% and 1% by weight, the gum blend comprising, in descending order of amount, gum arabic, propylene glycol alginate and xanthan gum; wherein the icing is ready to use, flowable, protein-free, and hardens after exposure to air.

In the preferred embodiment of the first icing, the icing comprises sugar in an amount of between 79% and 80% (preferably between 79.5% and 79.8%) by weight, water in an amount of between 13% and 14% (preferably between 13.24% and 13.87%) by weight, corn syrup in an amount of 5% by weight, and the gum blend in an amount of 0.85% by weight. Preferably, the first icing further comprises citric acid.

Additional embodiments of ranges of ingredients are as follows. Sugar can be used, for example, in ranges of 77% to 82% by weight, 78% to 81% by weight, and 78.5% to 80.5% by weight. The gum blend can be used, for example, in the ranges of 0.70% to 1% by weight, 0.75% to 0.95% by weight, and 0.80% to 0.90% by weight. Corn syrup can be used, for example, in the ranges of 4% to 6% by weight, and 4.5% to 5.5% by weight. Water can be used, for example, in the ranges of 11% to 16% by weight, and 12% to 15% by weight.

Also in a preferred embodiment, the first icing further comprises one or more, and preferably all, of (i) a coloring agent, (ii) a natural and/or artificial flavoring agent, and (iii) a preservative. Preferably, the preservative is potassium sorbate in an amount of, for example, 0.10% by weight. The instant icings can be of any color including, without limitation, any shade of white, blue, red, green, black, purple, pink, yellow and orange. Coloring agents include, for example, FD&C (i.e., FDA certified) dyes, FD&C lakes, FD&C dispersions, natural colors, and mixtures thereof. Specific examples are titanium dioxide, FD&C Blue 1, FD&C Red 40 and FD&C Yellow 5. Likewise, the instant icings can be of any flavor (e.g., butter vanilla flavor).

In further preferred embodiments, (i) the first icing, when dry and hard, has a semi-gloss and smooth appearance, and (ii) the icing begins to set after exposure to air for four minutes and hardens after exposure to air for four hours or less.

This invention also provides a second decorative icing comprising (a) sugar in an amount of between 79% and 80% by weight; (b) water in an amount of between 13% and 14% by weight; (c) corn syrup in an amount of 5% by weight; (d) a gum blend in an amount of 0.85% by weight, the gum blend comprising, in descending order of amount, gum arabic, propylene glycol alginate and xanthan gum; (e) citric acid in an amount of 0.07% by weight; (f) butter vanilla flavor in an amount of 0.1% by weight; and (g) potassium sorbate; wherein the icing is ready to use, flowable, protein-free, and hardens after exposure to air. Preferably, the second icing further comprises a coloring agent.

The instant decorative icings employ gum mixtures. Gums, or hydrocolloids, are mainly long-chain, straight or branched polysaccharides that contain hydroxyl groups that can bond to water molecules. These chains can consist of 2,000 to over 10,000 monosaccharide units. The sugar monomers can contain linked side units, or substituent groups, such as sulfates, methyl ethers, esters and acetals. Gums can be neutral or anionic. It is this structure, the type and number of monosaccharides and their configuration and the type, number and location of the linked groups, that give each gum its particular characteristics.

In general, gums are used to influence texture and mouth feel, as well as water-binding and stabilization of crystallization properties of ice cream and confectionery products. Hydrocolloid choice is based on the functional properties required in the finished product, and the specific rheological characteristics help determine which hydrocolloid provides the necessary viscosity, elasticity or hardness. The gum must also be able to withstand processing. (Source: “Special Effects with Gums,” Food Product Design, December 1999, Weeks Publishing Company). For information regarding rheological measurements and viscosity see Brookfield's “More Solutions to Sticky Problems” Brookfield Engineering Labs., Inc., Middleboro, Mass.

The following gums are exemplary. Seed gums include locust bean gum, which has been processed industrially since the early 20^{th} century, and guar gum, which is known for its thickening properties and does not need to be heated to exhibit them, a great advantage for food processing. Both are used in sauces, ice creams and bakery products. Tree exudates include acacia gum (gum arabic), gum karaya, gum ghatti and gum tragacanth, which are all produced from saps. These saps harden as they exit the tree and are ground into fine flour. Acacia gum is used extensively in flavor emulsions. Marine gums are extracted from seaweed. Examples include carrageenan, alginate and agar. They are used in dessert creams and processed cheese. Xanthan gum is the only bacterial polysaccharide produced industrially on a large scale. It is created from a biotechnological fermentation process. It is used in sauces, dressings and meat products. Most chemically derived gums start out as cellulose and then are chemically modified to have certain attributes. The most common of these is CMC (carboxyl methyl cellulose). (Sources: Cargill Texturizing Solutions and Gum Technology Corp).

In the context of this invention, the gum solution improves (i) the ability of the icing to resist syneresis over time, (ii) icing flow characteristics without increasing viscosity, (iii) icing breaking (i.e., icing flow starting and stopping when the pouch is squeezed), (iv) the ability of icing to dry when exposed to air, and (v) the length of time required for the icing to dry. The gum blend used in the instant icings comprises, in descending order of amount, gum arabic, propylene glycol alginate and xanthan gum. In the preferred embodiment, the gum blend is TIC Pretested® Stabilizer Icing manufactured by TIC Gums, Inc.

The proper functioning of the subject icing when used on a cookie is directly related to the viscosity of the icing as measured using a Brookfield viscometer. The icing will perform in the viscosity range of 71,000 centipoise (cP) to 125,000 cP. It performs better when in the viscosity range of 75,000 cP to 110,000 cP, and performs best when in the viscosity range of 85,000 cP to 100,000 cP.

Corn syrup is also employed in the instant icings. In this context, corn syrup functions to (i) maintain icing viscosity; (ii) determine icing flow characteristics when expressed from the pouch; (iii) maintain icing shine upon drying; and (iv) inhibit icing crystallization during storage in the pouch.

This invention further provides a first article for use in decorating a confection with icing comprising a squeezable pouch having (a) the first decorative icing therein, and (b) a re-closeable pouch fitment which, once opened, serves as an aperture through which the icing flows upon the pouch being squeezed. This invention also provides a second article for use in decorating a confection with icing comprising a squeezable pouch having (a) the second decorative icing therein, and (b) a re-closeable pouch fitment which, once opened, serves as an aperture through which the icing flows upon the pouch being squeezed.

Preferably, the first and second articles are re-closeable (i.e., re-usable), and each further comprises a cap for sealing the aperture once the article has been used. Ideally, the articles further comprise instructions for use.

This invention further provides a first kit for use in decorating a confection with icing comprising a packaging material and a plurality of the first articles, wherein each article in the kit contains icing which is colored differently than the icing in at least one other article in the kit. This invention further provides a second kit for use in decorating a confection with icing comprising a packaging material and a plurality of the second articles, wherein each article in the kit contains icing which is colored differently than the icing in at least one other article in the kit. Ideally, the kits further comprise suggestions for decorating cookies.

In the context of this invention, the term “confection” includes, without limitation, any baked good to which icing can adhere. Preferred here are baked goods having a flat, horizontal surface which can support larger quantities of icing. Cookies in particular are the preferred confection.

This invention also provides a method for making the first decorative icing comprising the steps of (a) admixing a gum solution with sugar, wherein the gum solution comprises water, potassium sorbate and, in descending order of amount, gum arabic, propylene glycol alginate and xanthan gum; (b) to the resulting mixture, admixing corn syrup for a suitable period of time; (c) to the resulting mixture, admixing sugar and citric acid for a suitable period of time; and (d) to the resulting mixture, admixing sugar for a suitable period of time.

Preferably, the method comprises the steps of (a) admixing a gum solution (between 13.8% and 14.0% by weight) with sugar (between 40% and 41% by weight), wherein the gum solution comprises water, potassium sorbate and, in descending order of amount, gum arabic, propylene glycol alginate and xanthan gum; (b) to the resulting mixture, admixing corn syrup (between 4.9% and 5.1% by weight), flavoring, and one or more coloring agents for four minutes; (c) to the resulting mixture, admixing sugar (15.7% to 15.9% by weight) and citric acid solution (50% solution, 0.13% to 0.15% by weight) for four minutes; and (d) to the resulting mixture, admixing sugar (23% to 24% by weight) for seven minutes.

Finally, this invention provides methods for decorating a confection comprising applying the first or second decorative icing to the confection, and permitting the icing so applied to dry. Preferably, these methods employ the first or second article to apply the decorative icing to the confection. The confections so decorated are also provided.

In sum, this invention has significant and unexpected advantages over existing icing products. This icing (i) is ready-to-use, in that there is no need for a mixing bowl, measuring and mixing utensils, pastry bags and tips (either reusable or disposable), or heating, (ii) has at least a one-year shelf life, (iii) when applied to a cookie, it dries smooth and firm; (iv) it dries within four hours; (v) one pouch of icing covers 12 2-inch cookies, and (vi) it dries with a semi-matte finish. In addition, it is fat-free and contains no allergens (dairy, wheat, egg and soy).

This invention will be better understood by reference to the Examples which follow, but those skilled in the art will readily appreciate that the examples detailed are only illustrative of the invention as described more fully in the claims which follow thereafter.

### EXAMPLES

### Example 1

### Parameters for Making Cookie Icing

There are several parameters that must be adhered to for optimum functionality of the subject cookie icing product. There can be deviations, but the results will not be as satisfactory. Parameters that were determined to be optimum include specific raw materials, particle size of the raw materials, mixing sequence, mixer type and mixing time.

Through much testing, it was determined that hydrocolloids, or gums, would be the primary ingredient system used to replace the allergen ingredient, egg, and to control functional properties of water binding, viscosity, and drying time of the icing. While systems using soy protein and corn starches were initially successful, they did not bind sufficient water to keep the icing from separating over time. Systems using xanthan gum and soy protein did improve water binding properties. However, the viscosity was too high, and the final icing was not smooth in appearance. Using gum arabic, corn starches and emulsifiers also worked initially, but the viscosity continued to climb over time, making the icing too thick to express from the package. A system combining gum arabic and xanthan gum worked for 2 weeks before separating, indicating the water was not sufficiently bound in the matrix. A guar and cellulose gum system was tried with poor functionality results, syneresis and very long dry times. Eventually the optimal formula was determined that uses a blend of hydrocolloid gums containing gum arabic, propylene glycol alginate, and xanthan gum. These gums, used together, were able to provide adequate sugar crystallization control, water binding, viscosity, and consumer functionality.

Particle size is important for hydration of ingredients, viscosity of the icing, water binding properties, sugar crystallization control, and consumer functionality traits such as smoothness in appearance and texture, and flow or spread on the confectionery surface. While extra fine granulated sugar (grain size of 0.5 mm across) would produce an icing, the consumer traits would be gritty and rough for both appearance and mouth feel. A better particle size would be 0.2 mm, without flow agents. This would give a functional icing with less grittiness, but the icing would not flow properly to cover the surface of the confection. The larger particle size of both the 0.5 mm and 0.2 mm sugars would promote a liquid/solid phase separation of the icing, therefore dramatically reducing shelf life. The sugar granulation size for optimal consumer acceptance and shelf stability would be <0.15 mm, without flow agents.

The cookie icing manufacturing process can be made in a single mixer. The icing will be functional but it will not maintain consumer functionality over time. If using one manufacturing process, all ingredients will be added to a single mixer in stages. The order of ingredient addition is necessary to allow all the ingredients to fully hydrate. A typical mixing order would be: (i) dry blend the gum mixture with a portion of the sugar; (ii) add liquid portions of the formula (water, liquid flavor, liquid color solutions); (iii) add preservatives and corn syrup; (iv) add citric acid; and (v) add remaining sugar.

One of the main problems with a single stage mixing process is the incomplete hydration of the gum blend. If the blend is not fully hydrated it cannot perform its intended functions. The icing may separate, may have syneresis, may be too thick or too thin, and/or may not dry on the confectionery product.

The optimal process uses two (2) mixers, where process #1 precedes process #2. A typical mixing order would be: (i) to mixer #1 (high shear), add water, gum blend and preservative; (ii) to mixer #2 (Conical), add gum solution and a portion of sugar; (iii) to mixer #2 (Conical), add flavoring, coloring, additional water and corn syrup; (iv) to mixer #2 (Conical), add citric acid, and a portion of sugar; and (v) to mixer #2 (Conical), add remaining portion of sugar.

Mixer #1 (high shear) is necessary to the process as it is able to fully hydrate the gum blend using high shear, which mechanically separates the gum particles, allowing water to bind with each particle. For information regarding high shear mixers see “Hydration of Xanthan Gum,” Silverson Machines, Inc., East Longmeadow, Mass.

Mixing order and mixing times are required to achieve the desired viscosity of the finished product. This is important for processing conditions and for consumer functionality traits. If mixing times are extended or shortened, too much or too little air may be incorporated into the icing. Too much air or too little air will either accelerate or inhibit the drying process. It may also increase or decrease the viscosity of the product. Flavor and color are added at levels to suit the user.

Table 1 sets forth specific examples of production protocols for the subject pouched cookie icing product. These protocols are provided by way of example, and are not intended to limit the scope of the subject invention.

TABLE 1
Pouched Cookie Icing Formula

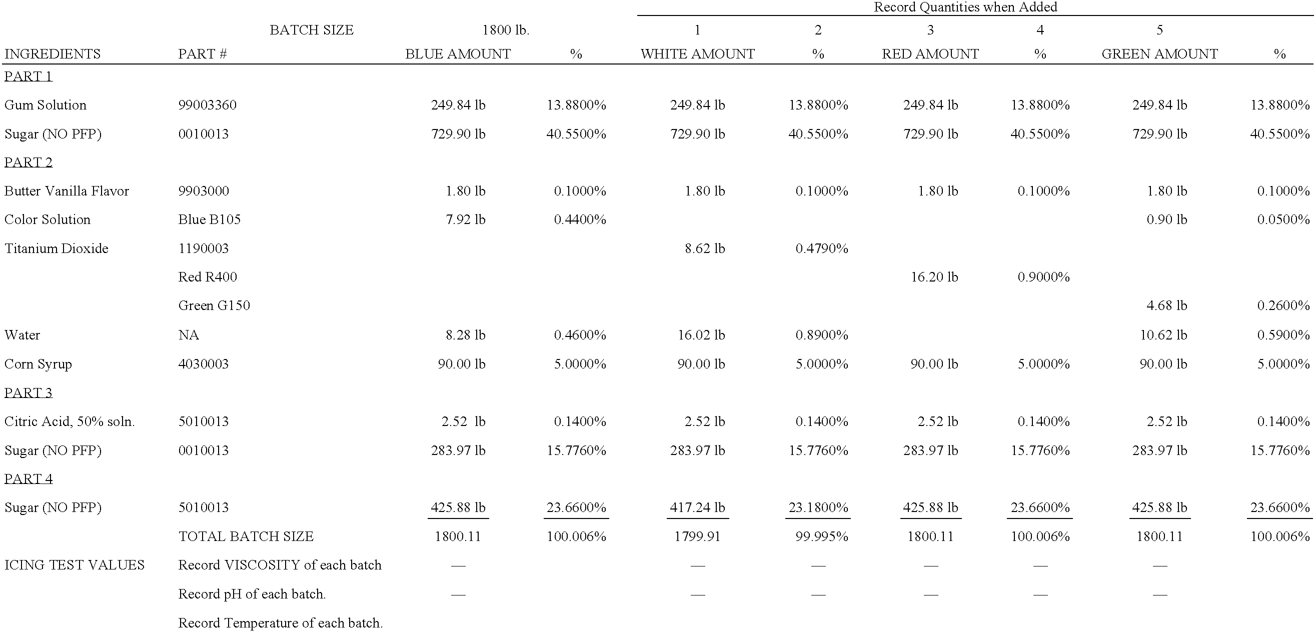

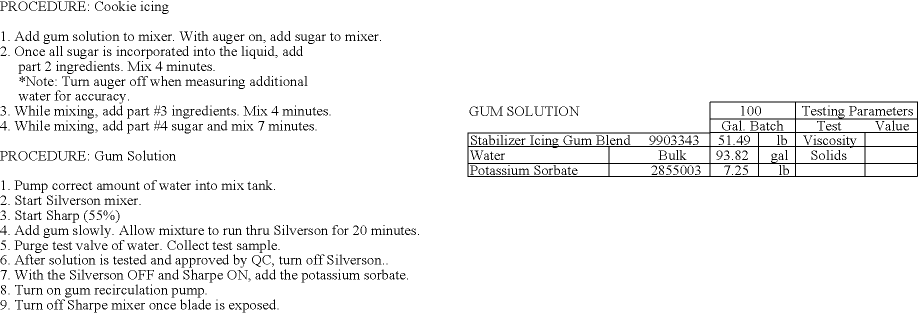

### Example 2

### Ice & Stack Cookie Decorating Icing Product

Generally: It is ready-to-use and comes in a disposable pastry bag so there is no prep time or clean up time. The icing sets up quickly, so the user can stack the cookies when done.

Packaging Format: Squeezable film pouch with resealable fitment

Colors: Any color

Flavors: Any flavor

Properties:
(i) Ready-to-use—requires no action, other than kneading, before use.
(ii) Flows readily from the pouch and require very little effort to smooth it out on a cookie, but does not run off the edges of the cookie.
(iii) Sets up for stacking within 4 hours (“stackability” can be measured by having a stack of 4 cookies, wherein the bottom cookie remains unchanged).
(iv) Has a smooth finish when icing is dry.

Shelf Life: 24 months

Complimentary Items: Intended for use on cookies. Most common usage is on sugar cookies and butter cookies.

### Example 3

### Wilton Ice-A-Cookie®

This product was commercially available until 2005.

Ingredients: sugar, water, corn syrup, partially hydrogenated vegetable oil (cottonseed and soybean), invert sugar, titanium dioxide (color), soy lecithin, agar, potassium sorbate (preservative), sodium benzoate (preservative), citric acid, mono and diglycerides, artificial flavor, locust bean gum.

Instructions:

To ice: (i) warm pouch in hot tap water to give icing a more fluid consistency; (ii) remove cap and snip tip; and (iii) ice cookie.

To decorate: (i) remove cap and snip tip; (ii) replace exclusive decorating tip on cap; and (iii) draw desired designs, such as line, curves, dots, messages and more. There is no need to warm the pouch.

If cookies have been iced, let set for 30 minutes to an hour before decorating. Covers approximately 24 3-inch round cookies. Dries completely in 6-8 hours. Best to dry overnight for use with FoodWriter™ Edible Color Markers.

In 2006, Wilton relaunched the product in a plastic squeeze bottle and renamed it “Cookie Icing.”

Ingredients: sugar, corn syrup, water, vegetable shortening [partially hydrogenated soybean oil, soybean lecithin, mono and diglycerides (soy)], contains less than 2% of corn starch, agar, locust bean gum, invert sugar, titanium dioxide (color), citric acid, natural and artificial flavors, sodium benzoate (preservative), potassium sorbate (preservative).

Directions:
1. Remove cap and aluminum seal. Microwave at 50% POWER 20-30 seconds. Carefully knead bottle to spread warmth. If needed, continue heating at 50% POWER, at 10 second intervals until all icing is soft and pourable.
2. Replace cap. Squeeze icing onto cookies; let dry for at least 45 minutes. Covers about 1 dozen 3-inch cookies.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A decorative icing comprising (a) sugar in an amount of between 65% and 85% by weight; (b) water in an amount of between 8% and 16% by weight; (c) corn syrup in an amount of between 1.5% and 7% by weight; and (d) a gum blend in an amount of between 0.3% and 1% by weight, the gum blend comprising, in descending order of amount, gum arabic, propylene glycol alginate and xanthan gum; wherein the icing is ready to use, flowable, protein-free, and hardens after exposure to air.

2. The icing of claim 1, wherein the icing comprises sugar in an amount of between 79% and 80% by weight, water in an amount of between 13% and 14% by weight, corn syrup in an amount of 5% by weight, and the gum blend in an amount of 0.85% by weight.

3. The icing of claim 1, further comprising citric acid.

4. The icing of claim 1, further comprising a coloring agent.

5. The icing of claim 1, further comprising a natural and/or artificial flavoring agent.

6. The icing of claim 1, further comprising a preservative.

7. The icing of claim 6, wherein the preservative is potassium sorbate.

8. The icing of claim 1, wherein the icing, when dry and hard, has a semi-matte and smooth appearance.

9. The icing of claim 1, wherein the icing begins to set after exposure to air for four minutes and hardens after exposure to air for four hours or less.

10. A decorative icing comprising (a) sugar in an amount of between 79% and 80% by weight; (b) water in an amount of between 13% and 14% by weight; (c) corn syrup in an amount of 5% by weight; (d) a gum blend in an amount of 0.85% by weight, the gum blend comprising, in descending order of amount, gum arabic, propylene glycol alginate and xanthan gum; (e) citric acid in an amount of 0.07% by weight; (f) butter vanilla flavor in an amount of 0.1% by weight; and (g) potassium sorbate in an amount of 0.1% by weight; wherein the icing is ready to use, flowable, protein-free, and hardens after exposure to air.

11. The icing of claim 10, wherein the icing further comprises a coloring agent.

12. An article for use in decorating a confection with icing comprising a squeezable pouch having (a) the decorative icing of claim 1 therein, and (b) a pouch fitment which, once opened, serves as an aperture through which the icing flows upon the pouch being squeezed.

13. The article of claim 12, wherein the article is reusable and further comprises a cap for sealing the aperture once the article has been used.

14. The article of claim 12, wherein the article further comprises instructions for use.

15. The article of claim 12, wherein the confection is a cookie.

16. An article for use in decorating a confection with icing comprising a squeezable pouch having (a) the decorative icing of claim 10 therein, and (b) a pouch fitment which, once opened, serves as an aperture through which the icing flows upon the pouch being squeezed.

17. The article of claim 16, wherein the article is reusable and further comprises a cap for sealing the aperture once the article has been used.

18. The article of claim 16, wherein the article further comprises instructions for use.

19. The article of claim 16, wherein the confection is a cookie.

20. A kit for use in decorating a confection with icing comprising a packaging material and a plurality of articles of claim 12, wherein each article in the kit contains icing which is colored differently than the icing in at least one other article in the kit.

21. The kit of claim 20, wherein the confection is a cookie.

22. The kit of claim 20, wherein the kit further comprises suggestions for decorating cookies.

23. A kit for use in decorating a confection with icing comprising a packaging material and a plurality of articles of claim 16, wherein each article in the kit contains icing which is colored differently than the icing in at least one other article in the kit.

24. The kit of claim 23, wherein the confection is a cookie.

25. The kit of claim 23, wherein the kit further comprises suggestions for decorating cookies.

26. A method for making the decorative icing of claim 1 comprising the steps of (a) admixing a gum solution with sugar, wherein the gum solution comprises water, potassium sorbate and, in descending order of amount, gum arabic, propylene glycol alginate and xanthan gum; (b) to the resulting mixture, admixing corn syrup for a suitable period of time; (c) to the resulting mixture, admixing sugar and citric acid for a suitable period of time; and (d) to the resulting mixture, admixing sugar for a suitable period of time.

27. The method of claim 26, wherein the method comprises the steps of (a) admixing a gum solution (between 13.8% and 14.0% by weight) with sugar (between 40% and 41% by weight), wherein the gum solution comprises water, potassium sorbate and, in descending order of amount, gum arabic, propylene glycol alginate and xanthan gum; (b) to the resulting mixture, admixing corn syrup (between 4.9% and 5.1% by weight), flavoring, and one or more coloring agents for four minutes; (c) to the resulting mixture, admixing sugar (15.7% to 15.9% by weight) and citric acid solution (50% solution, 0.13% to 0.15% by weight) for four minutes; and (d) to the resulting mixture, admixing sugar (23% to 24% by weight) for seven minutes.

28. A method for decorating a confection comprising applying the icing of claim 1 to the confection, and permitting the icing so applied to dry.

29. The method of claim 28, wherein the confection is a cookie.

30. A method for decorating a confection comprising applying the icing of claim 10 to the confection, and permitting the icing so applied to dry.

31. The method of claim 30, wherein the confection is a cookie.

32. A method for decorating a confection comprising applying decorative icing to the confection using the article of claim 12, and permitting the icing so applied to dry.

33. The method of claim 32, wherein the confection is a cookie.

34. A method for decorating a confection comprising applying decorative icing to the confection using the article of claim 16, and permitting the icing so applied to dry.

35. The method of claim 34, wherein the confection is a cookie.

36. A confection decorated by the method of claim 28.

37. The confection of claim 36, wherein the confection is a cookie.

38. A confection decorated by the method of claim 30.

39. The confection of claim 38, wherein the confection is a cookie.
